(19) United States
(12) Patent Application Publication
(10) Pub. No.: US 2015/0365229 A1
(43) Pub. Date: Dec. 17, 2015

(54) METHOD OF XOR HOMOMORPHIC ENCRYPTION AND SECURE CALCULATION OF A HAMMING DISTANCE

(71) Applicants: MORPHO, Issy-Les-Moulineaux (FR); INSTITUT MINES TELECOM, Paris (FR)

(72) Inventors: Alain Patey, Issy Les Moulineaux (FR); Herve Chabanne, Issy Les Moulineaux (FR); Gerard Cohen, Paris (FR)

(73) Assignee: MORPHO, Issy Les Moulineaux (FR)

(21) Appl. No.: 14/764,955

(22) PCT Filed: Jan. 30, 2014
(86) PCT No.: PCT/EP2014/051759

§ 371 Date: Jul. 30, 2015

(30) Foreign Application Priority Data
Feb. 1, 2013 (FR) 1350904

(51) Int. Cl. H04L 9/00; H04L 9/08

(52) U.S. Cl. CPC H04L 9/008; H04L 9/0869

(57) ABSTRACT

The invention concerns a method for encrypting a binary data item characterised in that it comprises the steps consisting of: —generating a public key and a private key, the public key being a sparse matrix comprising m rows and n columns, m being greater than the number I of bits of the binary data item, I being an integer strictly greater than 1, and the private key being a set of I indexed sets of integers between 1 and m such that for each set, the sum of the elements of the rows of the sparse matrix indexed by the elements of a set is zero, and—generating a binary sequence b comprising m bits, such that b=Mx+e+y in which o x is a random binary vector, o e is a random binary noise vector, and o y is a linear encoding of data item c. The invention also concerns a method for calculating a Hamming distance on data encrypted by the method of encryption.

### FIELD OF THE INVENTION

The invention generally relates to an encryption method of binary data and its application to secure calculation of Hamming distances between two data.

The invention applies especially to the field of biometric identification or authentication.

### PRIOR ART

Many techniques of biometric identification or authentication are already known. In general, they are executed jointly by a control server of an individual or an object, who can carry out acquisition of a biometric datum on an individual or an object, and by a management server of a base comprising N biometric data of the same kind.

The datum of the individual or of the object, acquired by the control server, is compared to all the data of the base so as to identify whether at least one datum of the base corresponds to the acquired datum, and identify the individual or the object as an individual or an object indexed in the base.

For this to happen, it is usual to calculate the Hamming distance between the datum of the individual and one or more data of the base, that is, the number of bits different from one datum to the other. This number can conventionally be calculated by performing the “exclusive OR” operation (known under the acronym XOR) between the two data, then by counting the Hamming weight, that is, the number of bits at 1 of the result obtained.

A major problem in this context is ensuring the confidentiality of data used. Indeed, the database comprises private information which the control server must not be able to access, and inversely the management server must not obtain information on the individual, and especially must not have access to the biometric datum which is exploited.

To respond to this problem, secure calculation techniques have been developed which let servers perform calculations on encrypted data to obtain calculation results without decrypting the data or having access to them.

In particular, a data encryption and secure calculation technique on the encrypted data by this technique has been developed to perform the “exclusive OR” operation between two data.

This technique is described in the publication by S. Goldwasser and S. Micali, Probabilistic encryption and how to play mental poker keeping secret all partial information, in H. R. Lewis, B. B Simons, W. A. Burkhard, L. H. Landweber (eds.) STOC, pp. 365-377. ACM (1982).

The main drawback to this method is that it encrypts only the data bit by bit, which considerably prolongs the calculation time necessary for its execution.

There is therefore a need for development of a faster data encryption method enabling secure calculation of a Hamming distance.

### PRESENTATION OF THE INVENTION

The aim of the invention is to eliminate the insufficiencies of the prior art by proposing a method for data encryption and secure calculation of Hamming distance on whole data, and not bit by bit.

Another aim of the invention is to propose a method for secure identification or authentication of an individual.

In this respect, the aim of the invention is an encryption method of a binary datum characterized in that it comprises the steps consisting of:
generating a public key and a private key, the public key being a sparse matrix comprising m lines and n columns, m being greater than the number I of bits of the binary datum, I being an integer strictly greater than 1, and the private key being a set of I indexed sets of integers between 1 and m such that for each set, the sum of the elements of the lines of the sparse matrix indexed by the elements of a set is zero, and
generating a binary sequence b comprising m bits, such that b=Mx+e+y where
   x is a random binary vector,
   e is a vector of random binary noise, and
   y is a linear encoding of the datum c.

Advantageously, but optionally, the encryption method according to the invention can further comprise at least one of the following characteristics:
the elements of the random noise vector e are Bernoulli variables.
encoding y of the datum c is configured so that partial knowledge of the coded datum y is not decodable.
encoding y of the datum c is linear coset coding, that is y is an element randomly selected from the elements verifying the relation H^{t}y=c, where H is a control matrix of a linear code.
generation of the public key and of the private key comprises:
   generation of I indexed matrices of q lines and n columns, where q is strictly less than m, the lines of each matrix each comprising three 1 and the columns of each matrix each comprising zero or two 1,
   generation of a sparse matrix M comprising m lines and n columns,
   random generation of I indexed sets of integers between 1 and m such that each set comprises q elements whereof its index and such that two separate sets comprise no common element, and
   for each indexed set, replacement of the lines of the sparse matrix M indexed by the elements of the set, by the lines of the corresponding indexed matrix.
generation of the public key and of the private key comprises:
   generation of I d-sparse indexed matrices Hⱼ, where d is an even integer greater than 3, each comprising q lines and q/3 columns, where q is strictly less than m, each line of a matrix comprising d 1,
   generation of a dsparse matrix M comprising m lines and n columns,
   random generation of I first indexed sets Uⱼ, j between 1 and I, of integers between I+1 and m such that:
      each set comprises q elements, and
      two separate sets comprise no common element,
   random generation of 1 second sets Tⱼ, j between 1 and I, of integers between 1 and n, such that each set Tⱼ comprises q/3 elements,
   for any j between 1 and I,
      replacement of the elements of M such that:

$${M}_{{u}_{k} , {t}_{q}} = {H}_{{j}_{k , q}}$$

for any uₖ∈Uj,t_{q}∈Tⱼ, and
   Mᵤ_{ₖ}_{,q}=0 if q∈Tⱼ
      permutation of the j^{th} line of M with a line of M indexed by an element of Uⱼ which is the sum of the lines of M indexed by the elements of a subset Wⱼ of Uⱼ,
   the public key obtained being the sparse matrix M and the private key being the set, for j between 1 and I, of the unions of the sets Wⱼ with the singleton j.

The invention also proposes a decryption method of an encrypted datum obtained by application to a binary datum of the encryption method described previously, the decryption method comprising:
for each set of indexed integers Sⱼ, the binary summation of the bits of the encrypted datum indexed by the elements of Sⱼ, each bit obtained corresponding to the bit indexed by j of the binary encoded datum, and the set of the indexed bits obtained forming the binary encoded datum, and
decoding of the datum obtained, the decoded datum forming the decrypted binary datum.

An application proposed by the invention is a method for secure calculation of the “exclusive or” operation between two binary encrypted data by carrying out the encryption method described hereinabove, comprising the steps consisting of:
determining, from encrypted data, a sequence of bits corresponding to encryption, by said encryption method, of the result of the “exclusive or” operation between the two binary data, and
decrypting the sequence of bits obtained by carrying out the decryption method.

Another application proposed by the invention is a method for secure calculation of a Hamming distance between two binary encrypted data by carrying out the encryption method described hereinabove, the method comprising the steps consisting of:
a) determining, from encrypted data, the result corresponding to the encryption by the encryption method, of the result of the “exclusive or” operation between the two nonencrypted data,
b) applying permutation σ to the I first bits of the result obtained at step a), and
c) decrypting the sequence of bits obtained at step b), and determining the Hamming weight of the datum obtained.

Advantageously, but optionally, the method for secure calculation of a Hamming distance proposed by the invention can further comprise at least one of the following characteristics:
the method is performed jointly by two processing units each holding one of the two binary data and a public key, a processing unit further holding the associated secret key, and in which:
   each processing unit encrypting the datum which it holds from the public key, the unit holding the secret key sending its encrypted datum to the second unit,
   the second unit performs steps a) and b) and transfers the result to the first unit, and
   the first unit performs step c).
the method is performed jointly by a server-unit holding the two encrypted data and the public key, and a client-unit holding the public key and the associated private key, and in which:
   the server-unit performs steps a) and b) and transfers the result to the client-unit, and
   the client-unit performs step c).

The invention also proposes a method for authentication or identification of an individual, comprising the comparison of a binary acquired datum on the individual with one or more reference binary data acquired on indexed individuals, each comparison comprising calculating the Hamming distance between the datum of the individual and a datum of the base, said calculation being performed by carrying out the method for secure calculation of a Hamming distance described hereinabove.

Advantageously, but optionally, in the method of authentication or identification of an individual, the datum of the individual and the datum or the data of the base are biometric data obtained by encoding the same biometric trait on the individual and the indexed individual(s).

The invention finally proposes a system of identification or authentication of an individual, comprising at least one control server of an individual to be identified or authenticated, and at least one management server of a reference database of indexed individuals, the control server being adapted to perform acquisition of a biometric binary datum of an individual, the control server and the management server being adapted to:
calculate at least one Hamming distance between the datum of the individual and at least one datum of the base by carrying out the method for secure calculation of Hamming distance described hereinabove, and
determining from the Hamming distance(s) calculated one or more data of the base having similarities with the datum of the individual exceeding a predetermined threshold.

### DESCRIPTION OF FIGURES

Other characteristics, aims and advantages of the present invention will emerge from the following detailed description with respect to the appended figures given by way of nonlimiting examples and in which:

FIG. 1 shows the main steps performed for encryption and decryption of data,

FIG. 2 shows the main steps performed for secure calculation of a Hamming distance,

FIGS. 3a and 3b show two variant embodiments of the calculation of a Hamming distance between two data.

### DETAILED DESCRIPTION OF AT LEAST ONE EMBODIMENT OF THE INVENTION

Context and Formalism

In what follows, operations are performed on binary data, that is, calculations must be made by numbering in base 2. So especially the nullity of a value corresponds to the nullity in base 2 of said value, that is, the value must be congruous to 0 modulo 2.

The following definition is also noted for hereinbelow: a ds-parse matrix, where d is an integer, is a matrix comprising d non-zero elements on each line, with the rest of the matrix comprising only 0.

Also, the function of homomorphic encryption is introduced for an operation•if, with two encrypted data c₁ and c₂ obtained by said encryption respectively from data m₁ and m₂, it is possible to determine the encrypted c₃ of a datum m₃=m₁·m₂ by knowing only the public key (and not the secret key) of the encryption employed.

### Method for Data Encryption and Decryption

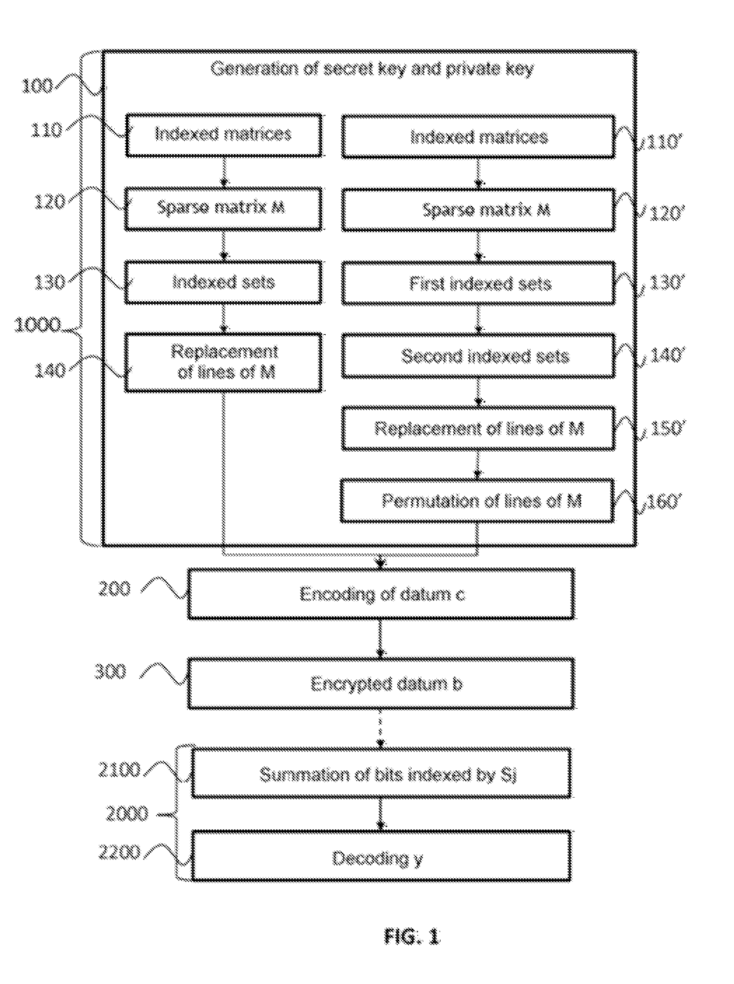

In reference to FIG. 1, this shows the main steps of an encryption 1000 and decryption 2000 method of binary data each comprising I bits, I being strictly greater than 1.

The encryption method is an asymmetrical encryption method, based on use of a public key pₖ accessible to everyone and enabling encryption of data, and a secret key sₖ accessible only to the recipient of the data, and necessary for performing data decryption.

The method therefore comprises a first step 100 for generating a public key pₖ and a secret key sₖ.

The public key pₖ is a d-sparse matrix M∈(0,1)^{m×n}, that is, the matrix comprises m lines and n columns, m and n being integers, and it comprises on each line d elements equal to 1, the rest of the matrix comprising only 0. d is therefore less than n.

The secret key sₖ is a set of I indexed sets(Sⱼ)_{j=1, . . . , c}, such that for any j between 1 and I, j∈Sⱼ and Σ_{i∈S}_{ⱼ}Mᵢ=0, where Mᵢ is the i^{th} line of M.

Generation of the public key and of the secret key can be performed in different ways, whereof two preferred embodiments are described hereinbelow.

According to a first embodiment, this step 100 comprises generation 110 of I indexed matrices Hⱼ selected uniformly from the matrices comprising q lines and n columns, and where each line of the matrix contains exactly three 1 and each column contains zero or two 1.

During a step 120, a 3-sparse matrix M is generated comprising m lines and n columns, m being greater than q, the lines of M being selected according to a law of uniform distribution.

During a step 130, I indexed sets Sⱼ are randomly generated, j between 1 and I, each comprising q integer elements between 1 and m, and such that for any j, j∈Sⱼ and Sⱼ∩Sₖ= for j≠k.

Next, during a step 140, for any j between 1 and l, the lines of M indexed by the elements of Sⱼ are replaced by the lines of H.

The public key pₖ is therefore M, and the private key sₖ is the set of Sⱼ {Sⱼ}_{j∈{1, . . . , l}}.

This method produces the characteristics of the public key and of the secret key described hereinabove, and especially the fact that each sum of the lines of the matrix M indexed by the elements of a Sⱼ is zero.

In fact, for each j, q lines of M are replaced by the q lines of the corresponding matrix Hⱼ. Now, each column of Hⱼ comprises just 0 or 2 elements equal to 1. The summation of these lines is therefore zero (that is, congruous to 0 modulo 2).

Alternatively, the generation step 100 of the public key pₖ and of the private key sₖ comprises generation, during a step 110′, of I d-sparse indexed matrices Hⱼ, j between 1 and I, d being an even integer greater than 3, and the elements of said matrices being selected according to a law of uniform distribution, each comprising q lines and q/3 columns, where q is strictly less than m.

During a step 120′, a d-sparse matrix M is generated comprising m lines and n columns.

During a step 130′, I indexed first sets Uⱼ⊂(l+1, . . . , m) are randomly generated, j between 1 and I, each comprising q elements, and such that two separate sets Uⱼ and Uₖ include no common element: Uⱼ∩Uₖ=.

During a step 140′, I second sets are randomly generated, j between 1 and I, of integers between 1 and n, such that each set Tⱼ comprises q/3 elements.

Next, during a step 150′, elements of M are replaced by elements of each matrix Hⱼ, j between 1 and l, as follows: Mᵤ_{ₖ}_{,t}_{_{q}}=Hⱼ_{_{k,q}} for any uₖ∈Uj, t_{q}∈Tⱼ, and Mᵤ_{ₖ}_{,tq}=0 if tq∉Tⱼ.

During a step 160′, an indexed line jᵢ of M is identified by an element of Uⱼ which is the sum of the lines of M indexed by the elements of a subset Wⱼ of Uⱼ, and this line is permutated with the j^{th} line of M. This line exists given the properties of the matrices and the sets generated during the preceding steps.

The public key Pₖ obtained is the matrix M and the private key sₖ is the set {Sⱼ=Wⱼ∪{j}}_{j∈{1, . . . , l}}.

The fact that the sum of the lines of M indexed by the elements of the Sⱼ is zero comes from the fact that the j^{th} line of M is equal to the sum of the lines of Wⱼ and that the additions are made in binary.

Following step 100 for generation of the public key and the private key, the encryption method comprises coding 200 of the binary datum c to obtain an encoded datum y.

Encoding is carried out by means of linear encoding for advantageously resolving the problem known as “wiretap channel”, disclosed and presented in the article by Wyner, A. D.: The wiretap channel, The Bell System Technical Journal 54(8), 1355-1387.

The problem disclosed in this article is proposing linear encoding for encoding a datum A to produce an encoded datum B such that, if B reaches a recipient via a nonnoised line, that is, B reaches its recipient without undergoing modifications, the recipient can decode them to obtain the datum A.

However, if B reaches its recipient via a noised line, that is, the third party has only a partial datum B, typically the case of an attack by a third party, it is impossible to decode it to obtain the datum A.

This type of encoding ensures that even partial knowledge of the encoded datum B produces the decoded datum A.

Coding verifying these properties is for example coding of the type called “coset coding”, also presented in the article.

Referring again to the encryption method, the coding step 200 of the binary datum c is advantageously performed by means of linear coset coding.

This type of encoding exploits a linear code C of parameters [n,k,d] with a control matrix H of dimensions (n-k)*k.

The encoding of a datum m is a datum x such that H^{t}x=m. The operation m=H^{t}x is performed to decode the encoded datum x.

In the case of the encryption method described in reference to FIG. 1, y is a vector of {0,1}^{l} randomly selected from the set of vectors verifying H·y=c, where c is the binary datum to be encrypted, and H is a control matrix of dimension r*l of the linear code on which the coset coding is based.

During a step 300, an encrypted datum b is generated such that b=M·x+e+(y₁, . . . , yₗ, 0, . . . , 0), where M is the public matrix, that is, the sparse matrix obtained at step 100, x is a vector in binary column randomly generated, of size n, e is an online vector of randomly generated binary noise, of size m, and the I first bits of the term (y₁, . . . , yₗ, 0, . . . , 0) are the elements of the encoding y of the datum c, and the m-I last bits are 0.

Advantageously, the elements of the noise vector e are Bernoulli variables, that is, they follow a Bernoulli law of parameter E: the elements of e therefore present the value 1 with a probability ∈. To note: e←^{R}Ber_{∈}^{m}.

∈ is preferably a very low value, of the order of n^{-0.2}. The role of this noise vector is to make searching of y from b difficult.

The encryption method performed here has a high level of security, especially due to encoding of the datum c by coding verifying the properties of the “wire-tap channel”.

In fact, as indicated earlier, this coding allows that any third party who might get partial knowledge of the encoded datum y would not manage to decode it.

In this case, a third party who might get the encrypted datum b therefore could not manage to decrypt it because, even if he were to get partial information on y, these would give him no information on the datum c. The encrypted datum b obtained therefore includes m bits.

Decryption 2000 of a datum b, comprising m bits, obtained by carrying out the method described hereinabove, will now be described. For this, it is necessary to have the secret key sₖ, that is, the set of indexed sets Sⱼ.

During a step 2100, the sum of the bits of b indexed by the elements of Sⱼ is calculated for each j between 1 and l, which corresponds to a bit yⱼ of the encoded datum y. The sequence of the yⱼ constitutes the encoded datum y=(y₁, . . . , y_{c}).

Indeed, the summation of the elements of M·x indexed by the elements of Sⱼ is zero, due to the choice of Sⱼ. The summation of the elements of b indexed by Sⱼ will therefore give yⱼ, added to a negligible error term. Consequently, the bits obtained by summation of the elements of b, indexed by the sets Sⱼ, are the bits of y, near noise.

During a step 2200, the obtained datum y is decoded by applying decoding of the linear code of the coset type, that is, c=H·y, where c is the binary datum decrypted.

The advantage of the proposed encryption method is being homomorphic for the “XOR” (exclusive OR) operation symbolised by the operator⊕, that is, for two messages c₁ and c₂ of l bits to be encrypted, the cipher of c₁⊕c₂ can be obtained from b₁ and b₂, the data obtained respectively by encryption of c₁ and c₂.

In this case, the exclusive or of b₁ and b₂ is a possible cipher of c₁⊕c₂ by the encryption method 1000, that is, performing the exclusive or operation between b₁ and b₂ corresponds to encryption of c₁⊕c₂ by the same encryption method 1000 with the same parameters.

This property derives from the linear character of the coset coding as used here.

Method for Secure Calculation of Hamming Distance

The encryption and decryption method described hereinabove allows performing secure calculation 3000 of Hamming distances between two binary data c₁ and c₂, this calculation being performed jointly by two processing units U₁ and U₂.

The notion of “secure” calculation indicates that the result of calculation must be obtained without either processing unit being able to access the data held by the other.

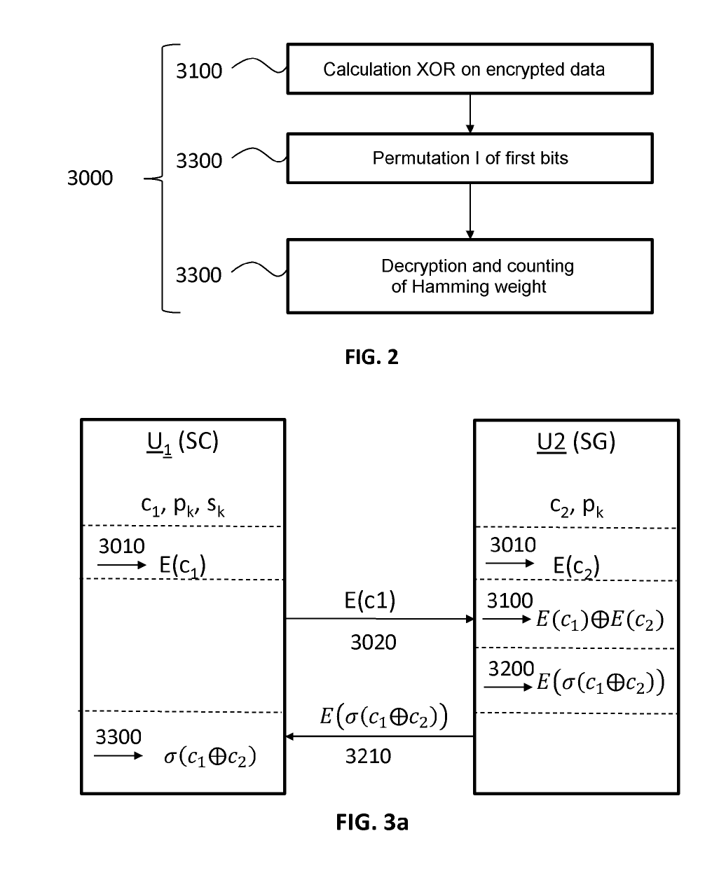

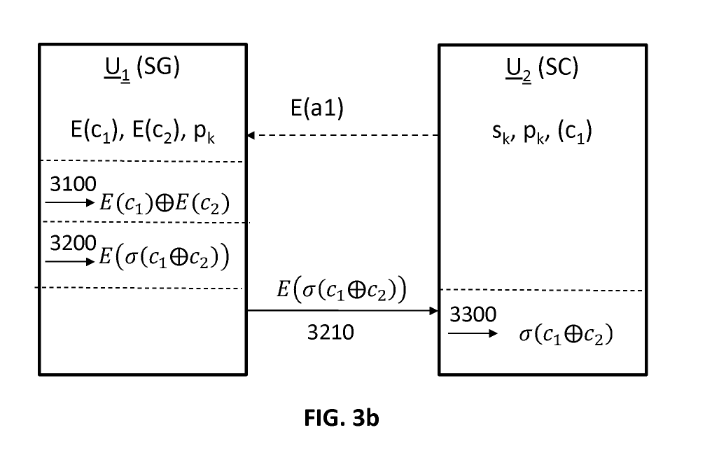

This calculation can be made according to two variants shown respectively in FIGS. 3a and 3b, the steps common to said variants being shown in FIG. 2.

In reference to FIG. 2, secure calculation of a Hamming distance between two binary data c₁ and c₂ is performed between the ciphers b₁ and b₂ corresponding to said data, obtained by carrying out the encryption method described hereinabove. It is evident hereinbelow that bᵢ=E(cᵢ) indicates that a datum bᵢ is the cipher of a datum cᵢ by this encryption method.

The calculation method comprises obtaining 3100 the cipher of the result of the exclusive OR operation between the nonencrypted binary data E(c₁⊕c₂), this result being obtained by performing the “exclusive OR” operation between the ciphers: b₁⊕b₂=E(c₁)⊕E(c₂), as per the homomorphic properties of the encryption method for the exclusive OR operation described hereinabove.

The method next comprises permutation 3200 of the I first bits of the result obtained at the preceding step by performing randomly selected permutation σ. The result obtained corresponds to the cipher of the permutation of the result of the “exclusive OR” operation between the two non-encrypted data cᵢ, that is, E(σ(c₁⊕c₂)). However, permutation does not modify the Hamming weight of a sequence of bits.

Because the message σ(c₁⊕c₂) has the same Hamming weight as c₁⊕c₂, this Hamming weight therefore corresponds to the Hamming distance between c₁ and c₂.

Therefore, during a step 3300 it suffices to decrypt the message E(σ(c₁⊕c₂)) and determine the Hamming weight of the result obtained to obtain the Hamming distance between c₁ and c₂.

As indicated hereinabove, several implementations of this method by processing units U₁ and U₂ are possible.

According to a first embodiment, illustrated in FIG. 3a, each processing unit U₁ and U₂ respectively has a binary datum c₁, c₂ and a public key pₖ of the type employed in the method described hereinabove. The corresponding secret key sₖ is held by one of the two units, for example U₁.

During a first step 3010, each processing unit encrypts the datum which it holds by carrying out the encryption method 1000 described hereinabove. The unit U₁ holding the secret key then transfers its encrypted datum E(c₁) to the other unit U₂ during a step 3020.

Next, the unit U₂ conducts the exclusive OR operation 3100 between the two encrypted data, selects and carries out permutation σ 3200 of the I first bits of the result obtained to produce E(σ(c₁⊕c₂)). The unit U₂ transfers this result to the unit U₁ during a step 3210 and the unit U₁ decrypts the result by carrying out the decryption method 2000 by way of the secret key sₖ which it holds, to obtain σ(c₁⊕c₂) and counts its Hamming weight to obtain the Hamming distance between c₁ and c₂.

Optionally, the result of the Hamming distance between the data can be communicated by unit U₁ to unit U₂.

According to an alternative embodiment, shown in FIG. 3b, the processing unit U₁ originally has the two already encrypted data E(c₁) and E(c₂) and the public key pₖ. The processing unit U₂ as such has the public key pₖ and the private key sₖ.

This situation applies especially in the case of dematerialised processing of data (“cloud computing”), where the unit U₁ is a remote server which stores confidential data of individuals and must not have access to them.

In this situation, it is the unit U₁ which carries out the exclusive OR operation 3100 between the two encrypted data, which selects and applies 3200 the permutation σ of the I first bits of the result obtained. Next, during a step 3210, the unit U₁ transfers E(σ(c₁⊕c₂)) obtained at step 3200 to the unit U₂.

During a step 3300, by application of the method 2000, by way of the secret key which it holds, the unit U₂ deciphers the datum received from the unit U₂ to obtain the datum σ(c₁⊕c₂), counts its Hamming weight and obtains the Hamming distance between c₁ and c₂.

Optionally, the unit U₂ can also transfer the Hamming distance between the data cᵢ to the unit U₁.

Application to Identification or Secure Authentication

This calculation method 3000 of a Hamming distance is advantageously applied to identification (comparison of an individual with a plurality of individuals as candidates for detecting correspondence between the individual and one of the candidates) or biometric authentication (comparison of an individual with an individual candidate for detecting correspondence) of an individual.

A biometric datum of an individual is compared to one (in the case of authentication) or more (in the case of identification) data of indexed individuals, each comparison being made by calculation of the Hamming distance between the data.

The biometric data are digital encodings of biometric traits of individuals and must correspond to the same biometric trait so they can be comparable: this trait can be one or two irises, one or more fingerprints, face shape, venous network shape, DNA, palm prints, etc.

A system for biometric identification or authentication 1 of an individual adapted to execution of the method 3000 advantageously comprises a control server SC of an individual to be identified and a management server SG of a biometric database, said base comprising at least one biometric reference datum cᵢ acquired on an individual indexed.

The control server SC advantageously comprises means for acquiring a biometric datum b on an individual to be identified or authenticated, and for example can be a reader of biometric fingerprints or identity document, or a camera.

The control SC and management SG servers are advantageously configured to execute one or the other of the variant embodiments of the method 3000 described hereinabove.

In the execution shown in FIG. 3a, the processing unit U1 advantageously corresponds to the control server SC which acquires a datum b on an individual to be identified and compares said datum to one or more data cᵢ held by the management server to obtain, for each cᵢ, the Hamming distance between the datum b and the datum cᵢ.

Typically, if a Hamming distance between b and one of the data cᵢ is less than a predetermined threshold, a correspondence is detected between the individual on whom the datum b has been acquired and the reference individual on whom the datum cᵢ has been acquired.

In the execution shown in FIG. 3b, the processing unit U₂ advantageously corresponds to the control server SC. In this case, the reference data stored in the base are already encrypted, such that the management server SG can access the encrypted data only, and the control server encrypting the datum b acquired on the individual prior to sending it to the management server.

In terms of the method 3000, the control server obtains the Hamming distance between the datum b and one or more data cᵢ of the base, and in the same way can detect correspondence between the individual and one or more indexed individuals.

An encryption method for securely calculating a Hamming distance on whole data therefore been presented, and no longer bit to bit, this calculation also able to be applied to biometric identification or authentication.

1. An encryption method of a binary datum (c) characterized in that it comprises the steps of:
generating a public key (pₖ) and a private key (sₖ), the public key being a sparse matrix (M) comprising m lines and n columns, m being greater than the number 1 of bits of the binary datum, 1 being an integer strictly greater than 1, and the private key being a set of 1 indexed sets (Sⱼ) of integers between 1 and m such that for each set, the sum of the elements of the lines of the sparse matrix indexed by the elements of a set is zero, and
generating a binary sequence b comprising m bits, such that b=Mx+e+y where
x is a random binary vector,
e is a vector of random binary noise, and
y is linear encoding of the datum c.

2. The encryption method of a binary datum according to claim 1, wherein the elements of the random noise vector e are Bernoulli variables.

3. The encryption method of a binary datum according to claim 1, wherein encoding y of the datum c is configured so that partial knowledge of the coded datum y is not decodable.

4. The encryption method of a binary datum according to claim 1, wherein encoding y of the datum c is a linear coset coding, that is y is an element randomly selected from the elements verifying the relation H^{t}y=c, where H is a control matrix of a linear code.

5. The encryption method according to claim 1, wherein the generation of the public key and of the private key comprises:
generation of 1 indexed matrices (Hj) of q lines and n columns, where q is strictly less than m, the lines of each matrix each comprising three 1 and the columns of each matrix each comprising zero or two 1,
generation of a sparse matrix M comprising m lines and n columns,
random generation of 1 indexed sets (Sj) of integers between 1 and m such that each set comprises q elements including its index and such that two separate sets comprise no common element, and
for each indexed set, replacement of the lines of the sparse matrix M indexed by the elements of the set, by the lines of the corresponding indexed matrix.

6. The encryption method according to claim 1 wherein generation of the public key and of the private key comprises:
generation of 1 indexed d-sparse matrices Hj, where d is an even integer greater than 3, each comprising q lines and q/3 columns, where q is strictly less than m, each line of a matrix comprising d 1,
generation of a d-sparse matrix M comprising m lines and n columns,
random generation of 1 first indexed sets Uj, j between 1 and l, of integers between 1+l and m such that:
each set comprises q elements, and
two separate sets comprise no common element,
random generation of 1 second sets Tj, j between 1 and l, of integers between 1 and n, such that each set Tj comprises q/3 elements,
for any j between 1 and l,
replacement of the elements of M such that:
$${M}_{{u}_{k} , {t}_{q}} = {H}_{{j}_{k , q}}$$
for any uₖ∈Uᵢ,L_{α}∈Tᵢ, and
Mᵤ_{ₖ}=0 if q∉Tᵢ
permutation of the jth line of M with a line of M indexed by an element of Uj which is the sum of the lines of M indexed by the elements of a subset Wj of Uj,
the public key obtained being the sparse matrix M and the private key being the set, for j between 1 and l, of the unions of the sets Wj with the singleton j.

7. The decryption method of an encrypted datum obtained by application to a binary datum of the method according to claim 1, the method comprising:
for each set of indexed integers Sj the binary summation of the bits of the encrypted datum indexed by the elements of Sj, each obtained bit corresponding to the bit indexed by j of the binary encoded datum, and the set of indexed bits obtained forming the binary encoded datum, and
decoding of the datum obtained, the decoded datum forming the decrypted binary datum.

8. A method of secure calculation of the “exclusive or” operation between two binary encrypted data by carrying out the method according to claim 1, comprising the steps of:
determining, from encrypted data, a sequence of bits corresponding to the encryption, by said encryption method, of the result of the “exclusive or” operation between the two binary data, and
decrypting the sequence of bits obtained, wherein decryption comprises:
for each set of indexed integers Sj, the binary summation of the bits of the encrypted datum indexed b the elements of Sj, each obtained bit corresponding to the bit indexed by j of the binary encoded datum, and the set of indexed bits obtained forming the binary encoded datum, and
decoding of the datum obtained, the decoded datum forming the decrypted binary datum.

9. A method of secure calculation of a Hamming distance between two binary data encrypted by the encryption method according to claim 1, the method comprising the steps of:
a) determining, from encrypted data, the result corresponding to encryption by the method according to claim 1, of the result of the “exclusive or” operation between the two non-encrypted data,
b) applying permutation σ to the 1 first bits of the result obtained at step a), and
c) decrypting the sequence of bits obtained at step b), and determining the Hamming weight of the datum.

10. The method of secure calculation of a Hamming distance according to claim 9, the method being executed jointly by two processor each holding one of the two binary data and a public key, a processor further holding the secret key associated, and wherein:
each processor encrypts the datum which it holds with the public key, the processor holding the secret key sending its encrypted datum to the second processor,
the second processor performs steps a) and b) and transfers the result to the first, and
the first processor performs step c).

11. The method of secure calculation of a Hamming distance according to claim 9, the method being performed jointly by a server-unit holding the two encrypted data and the public key, and a client unit holding the public key and the associated private key, and wherein:
the server-unit performs steps a) and b) and transfers the result to the client-unit, and
the client-unit performs step c).

12. A method of authentication or identification of an individual I, comprising comparison of a binary acquired datum on the individual to one or more reference binary data acquired on indexed individuals,
characterized in that each comparison comprises calculating the Hamming distance between the datum of the individual and a datum of the base, said calculation being done by carrying out the method according to claim 9.

13. The method according to claim 12, wherein the datum of the individual and the datum or the data of the base are biometric data obtained by encoding the same biometric trait on the individual and the indexed individual(s).

14. A system for identification or authentication of an individual, comprising at least one control server of an individual to be identified or authenticated, and at least one management server of a reference database of indexed individuals, the control server being adapted to perform acquisition of a binary biometric datum of an individual,
the system being characterized in that the control server and the management server are adapted to:
calculate at least one Hamming distance between the datum of the individual and at least one datum of the base, by carrying out the method according to claim 9, and
determining, from the calculated Hamming distance(s), one or more data of the base having similarities with the datum of the individual exceeding a predetermined threshold.
